(19) United States
(12) Patent Application Publication
(10) Pub. No.: US 2015/0267510 A1
(43) Pub. Date: Sep. 24, 2015

(54) Well Screen and Method of Manufacturing

(71) Applicant: Halliburton Energy Services, Inc., Houston, TX (US)

(72) Inventors: Stephen Michael Greci, McKinney, TX (US); Gregory Scott Cunningham, Grapevine, TX (US)

(21) Appl. No.: 14/432,706

(22) PCT Filed: Oct. 26, 2012
(86) PCT No.: PCT/US2012/062224

§ 371 Date: Mar. 31, 2015

(51) Int. Cl. E21B 43/08; E21B 43/10; B01D 35/02

(52) U.S. Cl. CPC E21B 43/08; B01D 35/02; E21B 43/10

(57) ABSTRACT

Disclosed herein is a screen for use in a subterranean location in a wellbore to filter solid materials from the hydrocarbons produced into the wellbore. The screen has a base pipe with inner and outer concentric shrouds mounted thereon. A sheet of filter screen mesh material is located in the annular space between the shrouds with its longitudinally extending edges unattached and overlapping a critical amount. The annular space is selected to be of a size such that the screen has is confined in a minimum space whereby hydrocarbon flow between the overlapping edges is closed off.

### CROSS-REFERENCE TO RELATED APPLICATIONS

This application is a United States national phase application which claims priority to International Application No. PCT/US2012/062224, filed Oct. 26, 2012, the entire disclosure of which is hereby incorporated herein by reference.

### STATEMENT REGARDING FEDERALLY SPONSORED

Not applicable.

### RESEARCH OR DEVELOPMENT

Not applicable.

### REFERENCE TO A MICROFICHE APPENDIX

Not applicable.

### BACKGROUND

The present invention relates to the filtering of fluids and, more particularly, to the sand screens used to filter hydrocarbon well fluids. Still, more particularly, the present invention relates to the method of manufacturing of such filters.

Well filters are typically used in subterranean well environments in which it is desired to remove a liquid or gas from the ground, without bringing soil particulates, such as sand or clay, up with the liquid or gas.

A well filter generally includes an inner support member, such as a perforated core and a filter body, including a filter medium disposed around the inner support member. In many cases, the well filter will further include an outer protective member, such as a perforated cage or shroud, disposed around the filter body for protecting it from abrasion and impacts. Filter material, such as wire mesh, is commonly positioned around a base pipe in an annular space formed between inner and outer cylindrical shrouds. It is common to wrap a sheet of filter material into a cylindrical shape with the abutting edges joined together by welding or the like to prevent solids from leaking through at the abutting edges.

A filter for subterranean use is described in U.S. Pat. No. 6,382,318, hereby incorporated herein by reference. A downhole screen and method of manufacture is described in U.S. Pat. No. 5,305,468, hereby incorporated herein by reference.

In order to facilitate installation of the shroud over the filter body, there is usually a clearance between the outer periphery of the filter body and the inner periphery of the outer protective member. It is well known in the art to form the outer shroud separately from the filter body and slide it over an end of the inner support member until it surrounds the filter body. In U.S. Pat. No. 7,287,684, the screen mesh material is helically wrapped about the support member. In U.S. Pat. No. 5,611,399, the mesh is wrapped around the support with the overlap being mechanically attached.

To avoid the expensive process of joining the edges of filter material to form a cylinder, a swaging process in used. In U.S. Pat. No. 6,305,468, the screen mesh is wrapped around the support member and forms a longitudinal seam. The seam is joined by swaging the outer shroud onto the inner layer to eliminate any space. In the swaging process, the shroud is disposed around the mesh and is plastically deformed radially inwardly to reduce the inner diameter of the shroud to a value such that the filter body can expand against the shroud. Swaging has several drawbacks, making it an undesirable step which should be avoided in manufacturing well filters. Swaging adds to the time and expense of manufacturing the filter. Also, swaging deforms the outer shroud, putting additional stresses on the shroud and affecting its material makeup.

Other common practices in the well filter industry also cause problems in manufacturing well filters. It is common to hand wrap the screen around the inner support. However, hand wrapping tends create unwanted slack in the filter. To combat this problem, the filter body is wrapped around the inner support longitudinally and a lengthwise weld is applied at the seam. Typically, a plasma or laser weld is used at the seam so as not to burn the fine mesh. However, this is time-consuming and expensive. Also, regardless of the type of weld used and care taken, welding causes the mesh in and around the weld to draw together, thereby causing the filter to bend and contort in undesirable ways. Welding weakens the area around the weld and, over time, can cause erosion and breakage.

Accordingly, there is a need for a filter and method of manufacturing such filter that eliminates the problems found with conventional filters and methods and is inexpensive to manufacture. The present invention overcomes the deficiencies of the prior art.

### SUMMARY

Disclosed herein are a sand screen mounted and a method of making the screen. The screen is mounted on a perforated base pipe that can be threaded on its ends for connection to a tubing string. Mounted concentrically around the base pipe is screen mesh located in a tight fit in the annular space, formed between inner and an outer concentric shrouds. The screen mesh is installed without connecting the edges. The screen mesh is wrapped around the inner shroud with the overlapping longitudinally-extending edges. The clearance space for the screen between the shrouds is controlled.

The ends of the shrouds and mesh are crimped on the base pipe to close off the annular spaces between the layers.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 is a side view of the sand screen, according to the present invention;

FIG. 2 is a cross-sectional view of the sand screen taken on line 2-2 of FIG. 1, looking in the direction of the arrows;

FIG. 3 is an enlarged, cross-sectional view of the sand screen overlap portion of FIG. 2 according to the present invention; and

FIG. 4 is a partial, longitudinal cross-sectional end view taken on line 4-4 of FIG. 1, looking in the direction of the arrows.

### DETAILED DESCRIPTION OF THE EMBODIMENTS

In the drawings and description that follow, like parts are typically marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to.” Reference to “up” or “down” will be made for purposes of description with “up,” “upper,” “upward,” or “upstream” meaning toward the surface of the wellbore and with “down,” “lower,” “downward,” or “downstream” meaning toward the terminal end of the well, regardless of the wellbore orientation. The term “zone” or “pay zone” as used herein refers to separate parts of the wellbore designated for treatment or production and may refer to an entire hydrocarbon formation or separate portions of a single formation, such as horizontally and/or vertically spaced portions of the same formation.

The various characteristics mentioned above, as well as other features and characteristics described in more detail below, will be readily apparent to those skilled in the art with the aid of this disclosure upon reading the following detailed description of the embodiments and by referring to the accompanying drawings.

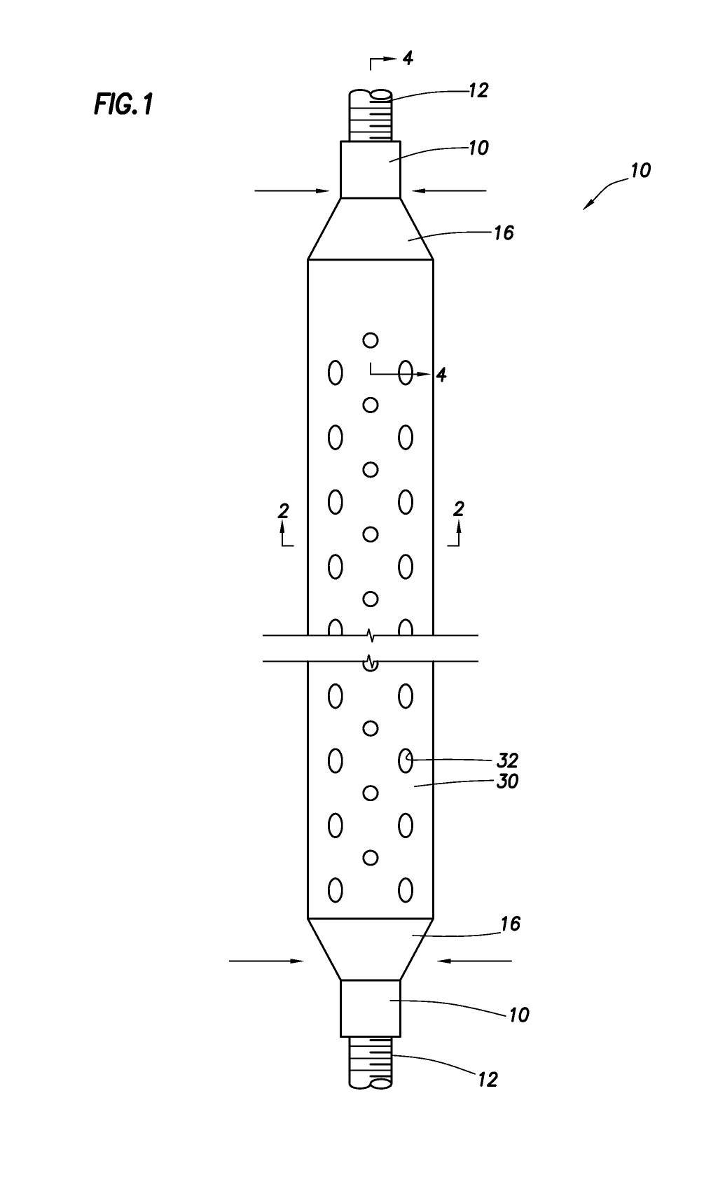

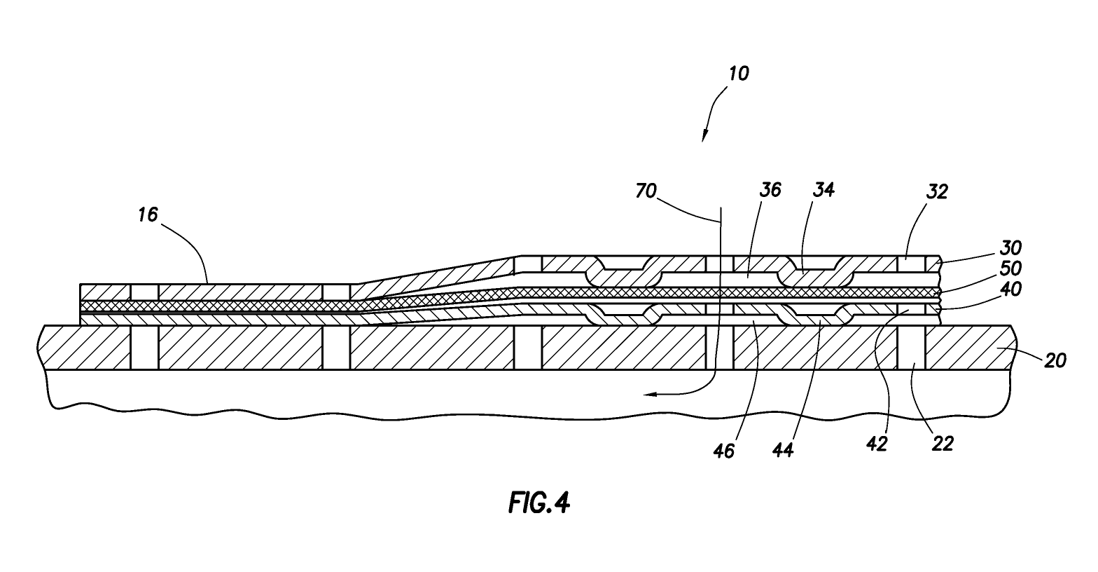

Referring now to the drawings wherein like reference characters are used throughout the several views to indicate like or corresponding parts, there is illustrated, in FIGS. 1-4, a sand screen assembly 10. In the disclosed embodiment, the sand screen assembly comprises an elongated base pipe 20 of sufficient structural integrity to be connected to a tubing string by threads 12 or the like. The base pipe supporting concentric outer layers including: an outer shroud 30, the inner shroud 40, and a screen mesh 50 wrapped around the inner shroud 40. As will be described in more detail, the outer layers sand screen assembly 10 has their ends crimped onto the base pipe 20, as indicated by reference numeral 16. The base pipe 20 includes perforations 22, extending through the wall of the base pipe 20 along the link between the crimped and 16. As used herein, the term “perforation” is not intended to be cross section shaped limiting and includes all shapes including, for example, perforations which are circular, oblong, and slit shaped. As is well known in the industry, these openings in the base pipe need only be of a sufficient size and shape to facilitate flow without destroying the structural integrity of the base pipe.

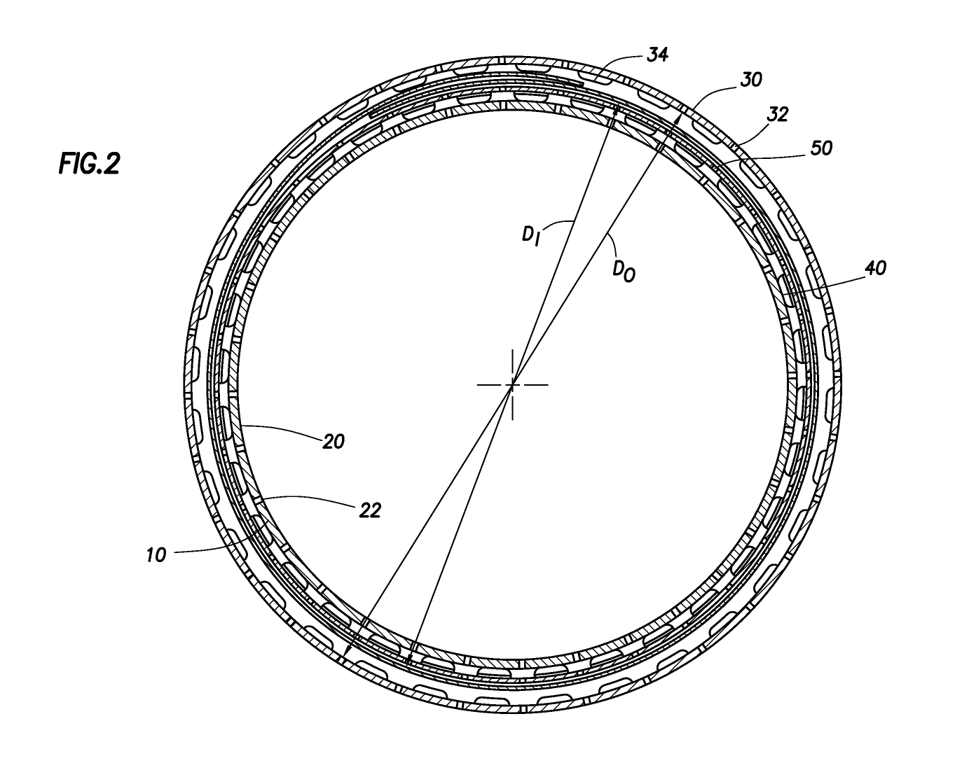

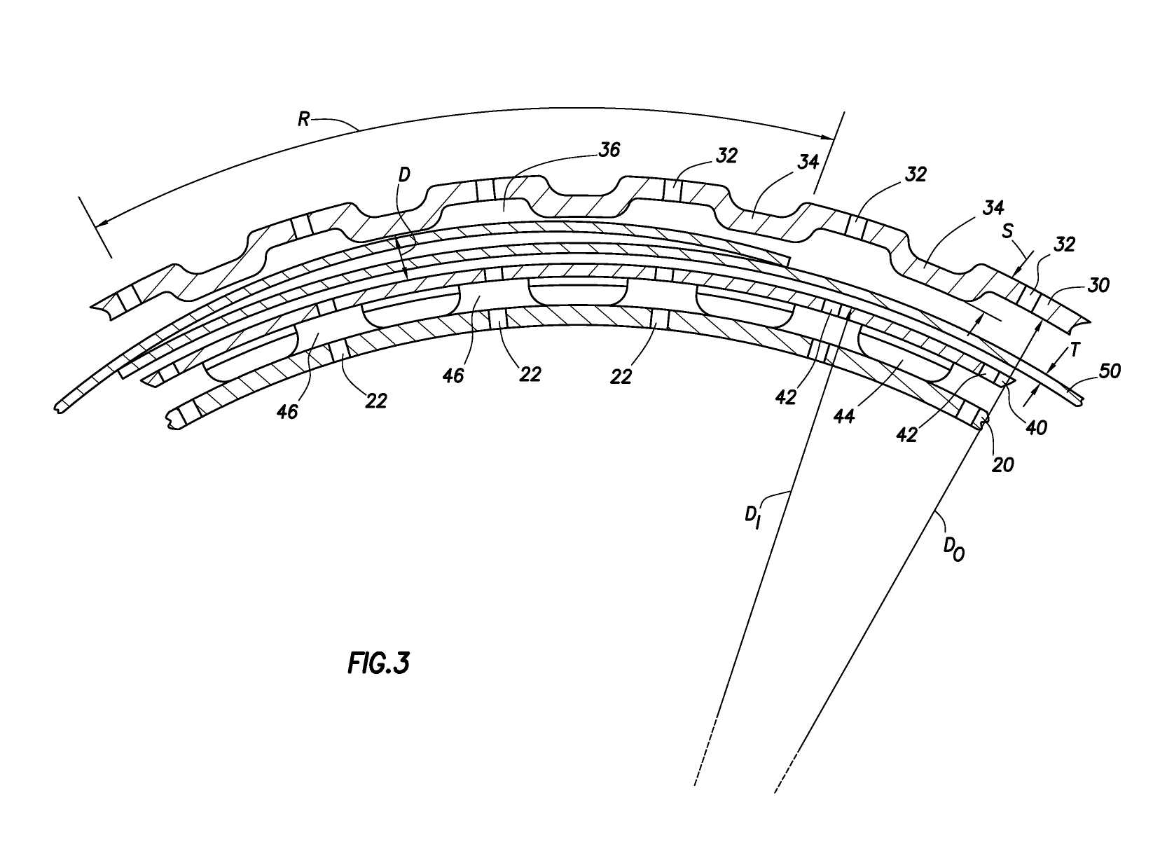

As illustrated in FIGS. 2 and 3, the outer shroud 30 is tubular shaped and includes a plurality of perforations 32 to allow hydrocarbons to flow into the screen assembly 10. Preferably, the outer shroud 30 is also provided with a plurality of deformations 34 which extend radially from the inner wall of the outer shroud 30. The inner shroud 40 is of a similar tubular construction. Perforations 42 extend through the wall of the shroud and deformations 44 extend inwardly from the inner wall.

The inner shroud fits closely around the base pipe 20 with the inner extensions of the deformations 44 contacting or in close proximity to the outer wall of the base pipe. The deformations 44 hold the inner shroud 40 away from the outer wall of the base pipe to form a drainage layer 46. Drainage layer 46 forms passageways between the base pipe 20 and the inner shroud 40 for hydrocarbons to flow through the screen mesh to the interior of the base pipe 20 through perforations 42. In some embodiments (not illustrated), the inner shroud is eliminated and the inner support for the screen mesh is the outer surface of the base pipe. In this embodiment, the screen material is wrapped around the base pipe with or without a drainage layer between the screen and base pipe. For purposes of description, the outside diameter of the inner screen support (in the embodiment of FIGS. 2 and 3) the inner shroud 40, is designated as “D_{I}”. When the screen mesh is wrapped around the base pipe, D_{I} would be the outer diameter of the base pipe.

The deformations 34 formed in the outer shroud 30 extend from the interior wall of the outer shroud. These deformations 34 function to form drainage areas 36 between the inner wall of the outer shroud 30 and the screen mesh 50. For purposes of description, the inside diameter of the outer shroud (ignoring the drainage layer) is designated as “D_{O}” as illustrated in in FIGS. 2 and 3. As shown in FIG. 3, the drainage layer thickness is designated by reference “S”.

In other configurations the drainage layers are formed by mesh material, as is well known in the industry. In some configurations, drainage two drainage layers are present in the annular space between the inner and outer shrouds. In this embodiment, drainage layers are located inside and outside of the screen. For purposes of description the total thickness of the drainage layers between the inner and outer shroud is designated as “DLT.” DLT is the sum of the thickness of the outer drainage layer plus the thickness of any inner drainage layer present in the screen.

The screen mesh 50 in the illustrated embodiment comprises a rectangular sheet of mesh material which is wrapped longitudinally around inner shroud 40. For purposes of description, the thickness of this mesh material will be identified by the reference “T”. Mesh material is utilized to filter solid materials from the hydrocarbons flow into the base pipe, as illustrated by arrow 70. Hydrocarbons entering the wellbore flow through the outershroud, screen mesh, inner shroud and into the interior of the base pipe 20. Various types of this screening material are well known in the industry.

According to the present invention, a screen can be manufactured without welding the screen edges or using swaging operations. As best illustrated in FIG. 3, the longitudinally extending outer edge 52 overlaps the longitudinally extending inner edge 54 by a circumferential distance “R”. When R is at least about one inch (1″) then the clearance space (“CS”) must be equal to or less than about one fourth of an inch (¼″), when the clearance space is determined by the formula CS=(D_{O}−D_{I})−3T−2DLT. According to the present invention, a screen assembled according to these specifications will not leak solids at the overlap.

According to the method of assembling the screen assembly 10, the inner and outer shrouds are formed as tubular from material that is perforated and deformed as described. Next, screen mesh 50 of thickness T is wrapped around the inner shroud 40 with the edges overlapping by a circumferential distance “R” measured between the layers. The edges are not welded, crimped or otherwise attached. Next, the outer shroud whose dimensions are selected according to the above formula is telescoped over the screen mesh 50 and inner shroud 40. The resulting assembly is telescoped over a perforated base pipe and the ends closed off by crimping onto the base pipe. No swaging is required.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations. Use of the term “optionally” or “preferably” used in the description with respect to any element of a claim means that the element is required, or alternatively, the element is not required, both alternatives being within the scope of the claim. Use of broader terms such as “comprises,” “includes,” and “having” should be understood to provide support for narrower terms such as “consisting of, “consisting essentially of,” and “comprised substantially of.” Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. A screen assembly for connection in a tubing string at a subterranean location in a wellbore to filter solids from liquids, comprising:
an elongated, perforated base pipe, having means for connection to a tubing string;
a cylindrical screen;
an elongated, perforated inner support for the screen; the cylindrical screen comprising sheet material wrapped around the inner screen support with longitudinally-extending edges overlapping a circumferential distance R;
an outer shroud of perforated tubular material positioned around the screen;
the distance R is at least about one inch; and
the maximum diametrical gap between the inner screen support and outer shroud is defined according to the following formula: CS=(D_{O}−D_{I})−3T−2DLT,
wherein:
CS is no greater than about one fourth of an inch;
D_{O} represents the inner diameter of the outer shroud;
D_{I} represents the outer diameter of the inner screen support;
T represents a cross-section thickness of the screen; and
DLT represents the total thickness of any and all drainage layers in the annular space between the inner support and outer shrouds.

2. The filter according to claim 1, wherein inner screen support comprises an inner shroud of perforated, tubular material positioned between the screen and the base pipe.

3. The filter according to claim 1, wherein the screen is mesh material.

4. The filter according to claim 1, wherein the base pipe is threaded on its ends for connection to a tubing string.

5. The filter according to claim 1, wherein no drainage layers are present between the outer shroud and the inner screen support and where DLT is equal to zero.

6. The filter according to claim 1, additionally comprising at least one drainage layer between the screen and the outer shroud and, wherein DLT is equal to the sum total of thicknesses of the drainage layers.

7. The filter according to claim 1, wherein the longitudinal ends of the screen and shrouds are crimped around the base pipe.

8. A method of manufacturing a screen subassembly for support from a tubing, comprising:
forming a screen subassembly by positioning screen material with overlapping, unjoined edges, the screen between a perforated, tubular inner screen support and outer perforated, tubular shroud according to the formula of claim 1;
supporting the screen subassembly on a base pipe attached to a tubing string;
placing the string at a subterranean location in a wellbore; and
filtering solids from liquids entering the tubing string.

9. The filter according to claim 8, wherein inner screen support comprises an inner shroud of perforated tubular material positioned between the screen and the base pipe.

10. The filter according to claim 8, wherein the screen is mesh material.

11. The filter according to claim 8, additionally comprising the step of threading the base pipe on its ends for connection to a tubing string.

12. The filter according to claim 8, wherein no drainage layers are present between the outer shroud and the inner screen support and where DLT is equal to zero.

13. The filter according to claim 8, additionally comprising the step of forming at least one drainage layer between the screen and the outer shroud and, wherein DLT is equal to the sum total of the drainage layer thicknesses.

14. The filter according to claim 8, additionally comprising the step of crimping the longitudinal ends of the screen, inner screen support and outer shroud around the base pipe.

15. A screen assembly for connection in a tubing string at a subterranean location in a wellbore to filter solids from liquids, comprising:
an elongated, perforated base pipe, connection means on the base pipe's ends for connection to a tubing string;
an elongated, perforated inner tubular shroud mounted around the base pipe, the inner shroud, a drainage layer formed between the inner shroud and the base pipe;
a cylindrical screen comprising sheet of mesh material of thickness T wrapped around the inner shroud, the longitudinally extending unattached free edges of the mesh material overlapping a circumferential distance of at least about one inch; and
an outer shroud of perforated, tubular material positioned around the inner shroud to form an annular space between the inner and outer shrouds; and
the maximum diametrical gap between the inner and outer shrouds remaining after subtracting three times the thickness of the screen mesh and two times the thickness of any and all drainage layers in the annular space between the inner and outer shrouds is no greater than at least about one fourth of an inch.

16. The filter according to claim 1, wherein the base pipe connection means comprises threads on the base pipe's ends.

17. The filter according to claim 15, wherein no drainage layers are present between the outer shroud and the inner screen support.

18. The filter according to claim 15, additionally comprising a drainage layer between the screen and the outer shroud.

19. The filter according to claim 15, wherein the longitudinal ends of the screen and shrouds are crimped around the base pipe.

20. A filter screen for use in a wellbore including an elongated, perforated base pipe, having means for connection to a tubing string, a cylindrical filter, an inner support for the filter, the filter cylinder comprising sheet material wrapped around the inner screen support with longitudinally extending edges overlapping, an outer shroud of tubular material positioned around the filter, wherein the improvement comprises the minimum distance the screen edges overlap is a circumferential distance of at least about one inch and the dimensions of the inner screen support and outer shroud according to the following formula:
CS=(D_{O}−D_{I})−3T−2DLT, wherein:
CS is no greater than about one fourth of an inch;
D_{O} represents the inner diameter of the outer shroud;
D_{I} represents outer diameter of the inner screen support;
T represents thickness of the screen; and
DLT represents the total thickness of any and all drainage layers in the annular space between the inner support and outer shrouds.
